(19) United States
(12) Patent Application Publication
(10) Pub. No.: US 2014/0257683 A1
(43) Pub. Date: Sep. 11, 2014

(54) METHOD AND APPARATUS FOR TESTING STATES IN FLIGHT PLAN STATE MANAGEMENT SYSTEM

(71) Applicants: ELECTRONICS AND TELECOMMUNICATIONS RESEARCH INSTITUTE, Daejeon (KR); INHA INDUSTRY PARTNERSHIPS INSTITUTE, Incheon (KR)

(72) Inventors: Byeong Cheol CHOI, Daejeon (KR); Seoung Hyeon LEE, Daejeon (KR); Deok Gyu LEE, Daejeon (KR); Yong Kyun KIM, Daejeon (KR); Jong-Wook HAN, Daejeon (KR); Hyo Dal PARK, Incheon (KR)

(73) Assignees: INHA Industry Partnerships Institute, Incheon (KR); Electronics and Telecommunications Research Institute, Daejeon (KR)

(21) Appl. No.: 13/873,515

(22) Filed: Apr. 30, 2013

(30) Foreign Application Priority Data
Mar. 11, 2013 (KR) 10-2013-0025650

(51) Int. Cl. G08G 5/00

(52) U.S. Cl. CPC G08G 5/003
USPC 701/120

(57) ABSTRACT

A method for testing states in a flight plan state management system is provided, which includes defining control variables for monitoring the flight plan state management system, modeling the flight plan state management system based on the control variables defined for monitoring, calculating and extracting control variables for testing the stability of, and checking for errors in, the flight plan state management system using the result of modeling, testing the stability of, and checking for errors in, the flight plan state management system based on the calculated and extracted control variables for testing stability and checking for errors, and expressing the result of stability testing and error checking on a display panel.

### RELATED APPLICATIONS(s)

This application claims the benefit of Korean Patent Application No. 10-2013-0025650, filed on Mar. 11, 2013, which is hereby incorporated by references as if fully set forth herein.

### FIELD OF THE INVENTION

The present invention relates to a technique of testing states in a flight plan state management system, and more particularly to a method and an apparatus for testing states in a flight plan state management system, which are suitable for efficiently testing the stability of, and checking for errors in, a flight plan state management system in a flight data processing system for air traffic control.

### BACKGROUND OF THE INVENTION

Recently, in relation to a flight data processing system for air traffic control, the state of flight plans and flight data are managed using a flight plan state management (FPSM) system.

However, at present, there is no technique for monitoring system stability, such as whether the state of flight plans is always managed at consistent levels, or whether there is any error in system processing. In consideration of the safe operation of aircraft as the highest priority, there is a strong demand for a technology for monitoring the stability of the flight plan state management system and providing the result of monitoring to a manager or an air traffic controller.

### SUMMARY OF THE INVENTION

In view of the above, the present invention provides a new stability monitoring technique for a flight plan state management system, which can extract specific coefficients through system modeling so as to analyze the stability, perform system error testing to determine whether the flight plan state management system operates normally without processing errors using the extracted coefficients and check the rate (stability) at which flight plans are processed normally by analyzing the result of flight plan state management processing during a predetermined period of time, and express (display) the test results via a display panel so that an air traffic controller (operator) can visually check the test result.

In accordance with an aspect of the present invention, there is provided a method for testing states in a flight plan state management system, which includes: defining control variables for monitoring the flight plan state management system; modeling the flight plan state management system based on the control variables defined for monitoring; calculating and extracting control variables for testing the stability of, and checking for errors in, the flight plan state management system using the result of modeling; testing the stability of the flight plan state management system and checking for errors therein based on the calculated and extracted control variables for testing the stability and checking for errors; and expressing the result of the stability testing and error checking on a display panel.

The control variables for monitoring may include at least one of an aircraft waiting state, a modeling state, a preparation state, a departing state, an arriving state, and a termination state.

The test of the stability may be performed through the following equation, which is based on a Bayesian network,

Pr(A|D,P,M,W)=Pr(W)Pr(M|W)Pr(P|W,T)Pr(D|P)Pr(A|D)

where W denotes a waiting state, M denotes a modeling state, P denotes a preparation state, D denotes a departing state, A denotes an arriving state, and T denotes a termination state.

The error checking may be performed through the two following equations,

$${\overline{s}}_{i} = \frac{1}{N} {\sum }_{j ∈ V ( i )} {w}_{ij}$$

where, V(i) denotes a node, wᵢⱼ denotes a weight value of a network link, and N denotes the total number of nodes.

Pr(A|D,P,M,W)=Pr(W)Pr(M|W)Pr(P|W,T)Pr(D|P)Pr(A|D)

where W denotes a waiting state, M denotes a modeling state, P denotes a preparation state, D denotes a departing state, A denotes an arriving state, and T denotes a termination state.

The modeling may be executed based on a network theory for modeling of a weighted and directed network.

The modeling may be executed through calculation and analysis of internal parameters of a model using a complex network theory and statistical graphical models.

In accordance with another aspect of the present invention, there is provided an apparatus for testing states in a flight plan state management system, which includes: a monitoring definition block, which defines control variables for monitoring the flight plan state management system; a modeling execution block, which executes modeling of the flight plan state management system based on the control variables defined for monitoring; a stability/error control variable generation block, which calculates and extracts control variables for testing the stability of, and checking for errors in, the flight plan state management system using the result of modeling; a state management stability test block, which tests the stability of the flight plan state management system based on the calculated and extracted control variables for testing stability; a state management error checking block, which checks for errors in the flight plan state management system based on the calculated and extracted control variables for checking for errors; and a screen expression block, which expresses the result of stability testing and error checking on a display panel.

The monitoring definition block may define at least one of an aircraft waiting state, a modeling state, a preparation state, a departing state, an arriving state, and a termination state as control variables for monitoring.

The stability test block may test the stability using the following equation,

Pr(A|D,P,M,W)=Pr(W)Pr(M|W)Pr(P|W,T)Pr(D|P)Pr(A|D)

where W denotes a waiting state, M denotes a modeling state, P denotes a preparation state, D denotes a departing state, A denotes an arriving state, and T denotes a termination state.

The error checking block may check for errors using the two following equations,

$${\overline{s}}_{i} = \frac{1}{N} {\sum }_{j ∈ V ( i )} {w}_{ij}$$

where V(i) denotes a node, wᵢⱼ denotes a weight value of a network link, and N denotes the total number of nodes.

Pr(A|D,P,M,W)=Pr(W)Pr(M|W)Pr(P|W,T)Pr(D|P)Pr(A|D)

where W denotes a waiting state, M denotes a modeling state, P denotes a preparation state, D denotes a departing state, A denotes an arriving state, and T denotes a termination state. The modeling execution block may execute the modeling based on a network theory for modeling of a weighted and directed network.

The modeling may be executed through calculation and analysis of internal parameters of a model using a complex network theory and statistical graphical models.

In accordance with the present invention, the stability of the result of the flight plan state processing can be monitored through analysis of the basic characteristics of the flight plan state management system, effective monitoring for system errors in the flight plan state management system can be realized, and through this, the overall stability of the flight plan state processing system for air traffic control can be improved.

### BRIEF DESCRIPTION OF THE DRAWINGS

The objects and qualities of the present invention will become apparent from the following description of embodiments given in conjunction with the accompanying drawings, in which:

FIG. 1 is a block diagram of an apparatus for testing states in a flight plan state management system in accordance with an embodiment of the present invention;

FIG. 2 is a conceptual diagram illustrating the result of system modeling to apply the apparatus for testing states in accordance with the present invention to a weighted and directed network;

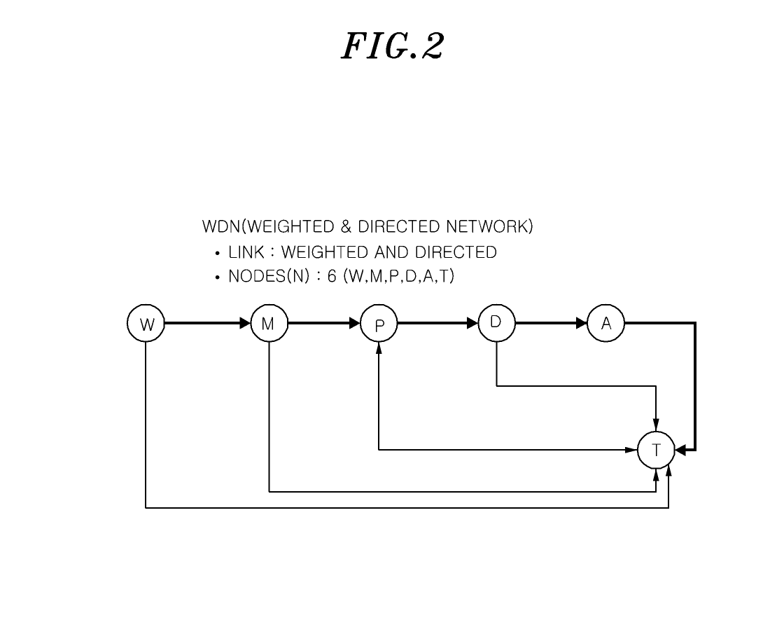

FIG. 3 is a flowchart illustrating a main process for performing state testing using a flight plan state management system in accordance with an embodiment of the present invention; and

FIG. 4 is a resultant table obtained by simulating and illustrating state changes with respect to 100 flight plans as an example of a weighted adjacent matrix.

### DETAILED DESCRIPTION OF THE EMBODIMENTS

The aspects and qualities of the present invention and methods for achieving the aspects and qualities will be apparent by referring to the embodiments to be described in detail with reference to the accompanying drawings. Here, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

Further, in the following description of the present invention, a detailed description of known functions and configurations incorporated herein will be omitted when it may make the subject matter of the present invention rather unclear. Also, the following terms are defined in consideration of the functions of the present invention, and may be differently defined according to the intention of an operator or custom. Therefore, the terms should be defined based on the overall contents of the specification.

Hereinafter, preferred embodiments of the present invention will be described in detail with reference to the accompanying drawings.

### Embodiment 1

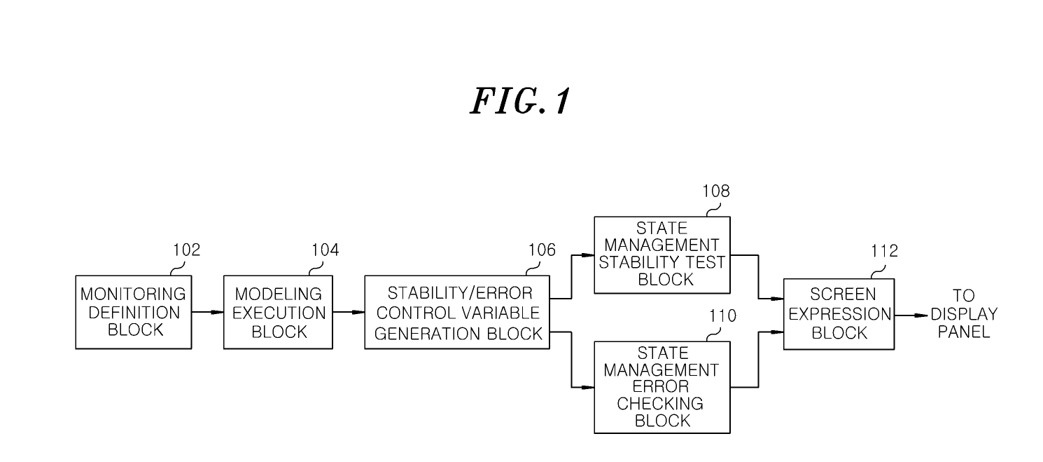

FIG. 1 is a block diagram of an apparatus for testing states in a flight plan state management system in accordance with an embodiment of the present invention. An apparatus for testing states in a flight plan state management system may include a monitoring definition block 102, a modeling execution block 104, a stability/error control variable generation block 106, a state management stability test block 108, a state management error checking block 110, and a screen expression block 112.

Referring to FIG. 1, the monitoring definition block 102 may define control variables for monitoring the flight plan state management system, and may transfer the defined control variables to the modeling execution block 104. Here, the control variables for monitoring may include at least one of an aircraft waiting (W) state, a modeling (M) state, a preparation (P) state, a departing (D) state, an arriving (A) state, and a termination (T) state.

The control variables for monitoring may be determined through initial setting of a flight data processing (FDP) system. They may differ in accordance with the particular requirements of an application site (airport), and in this case, a system developer may customize (develop) related software to match the corresponding application site.

Next, the modeling execution block 104 may execute modeling of the flight plan state management system based on the control variables defined for monitoring that are provided from the monitoring definition block 102, and may transfer the result of modeling to the stability/error control variable generation block 106. Here, the system modeling may be executed based on a network theory for modeling of a weighted and directed network (WDN), and the modeling based on such a network theory may be executed, for example, through calculation and analysis of internal parameters of a model using a complex network theory and statistical graphical models.

The stability/error control variable generation block 106 may calculate and extract control variables for testing the stability of, and checking for errors in, the flight plan state management system based on the result of system modeling provided from the modeling execution block 104. Here, the extracted control variables for testing the stability are transferred to the state management stability test block 108, and the control variables for checking for errors are transferred to the state management error checking block 110.

Alternatively, the state management stability test block 108 may test the stability of the flight plan state management system (that is, how stably the system processes the flight plans (airplane) without errors) based on the control variables for testing the stability that are provided from the stability/error control variable generation block 106, and may transfer the stability test result of the system to the screen expression block 112. That is, the state management stability test block 108 may test (confirm) the stability of the system using Equation (6), which will be described later.

Further, the state management error checking block 110 may check for errors in the flight plan state management system based on the control variables that are provided for checking for errors from the stability/error control variable generation block 106, and may transfer the system error checking result to the screen expression block 112. That is, the state management error checking block 110 may check (confirm) the errors of the system using Equations (2) and (6), which will be described later.

The screen expression block 112 may construct the system stability test result provided from the state management stability test block 108 and the system error checking result provided from the state management error checking block 110 as screen information that can be expressed (visually displayed) through a display panel (not illustrated), and then transfer the screen information to the display panel side. Here, the expression of the screen information on the display panel may be checked in a log file and a DB table from the viewpoint of the system manager, and may be checked (displayed) on a CWP (Controller Working Position) screen from the viewpoint of the air traffic controller.

That is, in accordance with the present invention, the modeling is executed based on the weighted and directed network (WDN), and internal parameters of a model are calculated and analyzed using complex network theory and statistical graphical models theory. The strength of node I, the normalized strength of node I, the weighted neighborhood degree of node I, and the weighted clustering coefficient of node I may be calculated using the following Equations (1) to (4).

$${s}_{i} = {\sum }_{j ∈ V ( i )} {w}_{ij} \qquad ( 1 )$$

In Equation (1), V(i) denotes a node, and wᵢⱼ denotes the weight value of a network link.

$${\overline{s}}_{i} = \frac{1}{N} {\sum }_{j ∈ V ( i )} {w}_{ij} \qquad ( 2 )$$

In Equation (2), N denotes the total number of nodes.

That is, since Equation (2) expresses a connection strength for each state transition stage (if the strength is high, the transition is performed well), the continuous processing performance of the system and the errors can be grasped (tested) through this.

$${k}_{nn , i}^{w} = \frac{N}{j = 1} {x}_{ij} {w}_{ij} {k}_{j} \qquad ( 3 )$$

In Equation (3), xᵢⱼ denotes the value of an adjacent matrix in the modeling result based on a complex network, and kⱼ denotes the degree of node j.

$${c}_{i}^{w} = \frac{1}{{s}_{i} ( {k}_{i} - 1 )} {\sum }_{j , h} \frac{( {w}_{ij} + {w}_{ih} )}{2} {x}_{ij} {x}_{ih} {x}_{jh} \qquad ( 4 )$$

In Equation (4),

$${\sum }_{j , h} \frac{( {w}_{ij} + {w}_{ih} )}{2} {x}_{ij} {x}_{ih} {x}_{jh}$$

has a value only in the case where the relationship between other nodes j and h, which are connected in a triangle form based on node i, is satisfied.

Then, the characteristic path length L for the system modeling may be calculated as in Equation (5)

$$L = \frac{1}{N ( N - 1 )} {\sum }_{i , j ∈ N , i \neq j} {d}_{i , j} \qquad ( 5 )$$

In Equation (5), dᵢⱼ denotes the number of links of the shortest path connecting node I and node j.

Further, the test of the system stability (success rate) may be calculated using the following Equation (6), which is based on a Bayesian network, and the test of the system errors may be calculated using the above-described Equation (2) and the following Equation (6).

Pr(A|D,P,M,W)=Pr(W)Pr(M|W)Pr(P|W,T)Pr(D|P)Pr(A|D) (6)

In Equation (6), W denotes a waiting state, M denotes a modeling state, P denotes a preparation state, D denotes a departing state, A denotes an arriving state, and T denotes a termination state.

That is, Equation (6) as described above means the probability of whether the initially input flight plan (airplane) progresses to the desired final state, which is arrival. According to Equation (6), the entire system grasps input/output simultaneously through graphic modeling, and thus it is preferable to maintain a relatively high probability value.

In other words, the present invention can analyze the basic characteristics of the flight plan state management system using the above-described Equation (1) to Equation (6), test the stability (success rate) of the flight plan state processing using the above-described Equation (6), and check for errors in the flight plan state processing system using the above-described Equation (2) and Equation (6).

Next, a series of processes for testing the state of the flight plan state management system using the apparatus for testing states having the above-described configuration in accordance with the present invention will be described in detail.

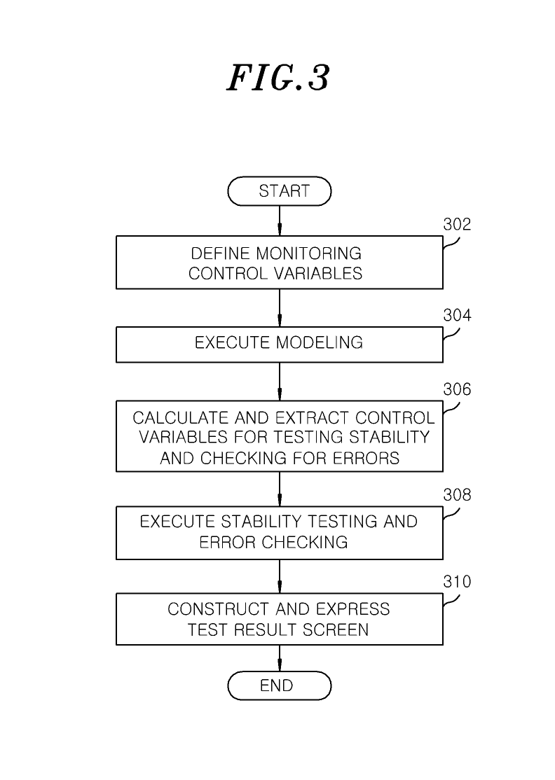

FIG. 3 is a flowchart illustrating a main process for performing state testing using a flight plan state management system in accordance with an embodiment of the present invention.

Referring to FIG. 3, when a test is requested by an operator (worker), the monitoring definition block 102 defines the control variables for monitoring the flight plan state management system, for example, control variables such as a waiting (W) state, a modeling (M) state, a preparation (P) state, a departing (D) state, an arriving (A) state, and a termination (T) state (Step 302).

Next, the modeling execution block 104 executes modeling of the flight plan state management system based on the control variables defined for monitoring (Step 304). Here, the system modeling may be executed based on a network theory for modeling of a weighted and directed network (WDN), and the modeling based on such a network theory may be executed, for example, through calculation and analysis of internal parameters of a model using complex network theory and statistical graphical models theory.

The stability/error control variable generation block 106 calculates and extracts control variables for testing the stability of, and checking for errors in, the flight plan state management system based on the result of system modeling (Step 306).

Then, the state management stability test block 108 tests the stability of the flight plan state management system based on the extracted control variables for testing stability, and checks for errors in the flight plan state management system based on the extracted control variables for testing the errors (Step 308).

Finally, the screen expression block 112 constructs (processes) the system stability test result and the system error checking result as screen information that can be expressed through a display panel (not illustrated), and then transfers the screen information to the display panel side. As a result, the system stability test and the error checking results will be expressed on the display panel (Step 310).

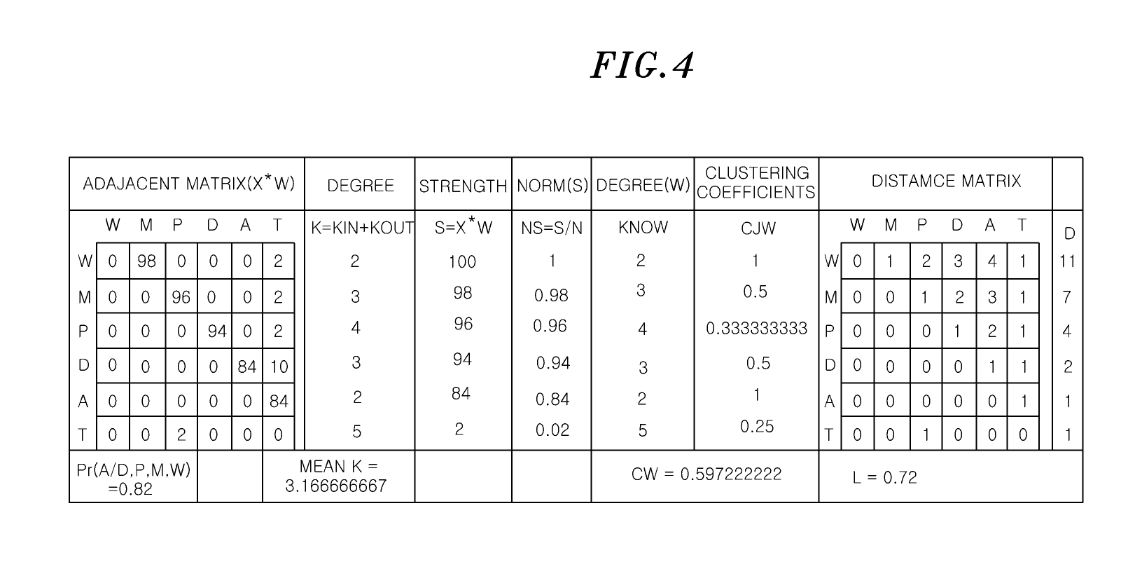

FIG. 4 is a resultant table obtained by simulating and illustrating state changes with respect to 100 flight plans as an example of a weighted adjacent matrix. Here, the most important things for the stability monitoring of the system are normalized strength values (Norm(s)) and conditional probability values Pr(A|D,P,M,W) based on complex network theory. In particular, conditional probability values may be used to analyze the success rate of the flight plan state management through calculation of the degree of the successful transition of flight plan states as a conditional probability based on the Bayesian network.

Accordingly, the inventors of the present invention can clearly know that the stability of the result of the flight plan state processing can be monitored through the simulation result and the monitoring of the system errors can be effectively implemented in the flight plan state management system.

The description of the present invention as described above is exemplary, and it will be understood by those of ordinary skill in the art to which the present invention pertains that various changes in form and detail may be made therein without changing the technical idea or essential features of the present invention. Accordingly, it will be understood that the above-described embodiments are exemplary in all aspects and do not limit the scope of the present invention.

Accordingly, the scope of the present invention is defined by the appended claims, and it will be understood that all corrections and modifications that can be derived from the meanings and scope of the following claims and equivalent concepts fall within the scope of the present invention.

What is claimed is:

1. A method for testing states in a flight plan state management system, comprising:
defining control variables for monitoring the flight plan state management system;
modeling the flight plan state management system based on the control variables defined for monitoring;
calculating and extracting control variables for testing stability and checking errors of the flight plan state management system using a result of modeling;
testing the stability and checking the errors of the flight plan state management system based on the calculated and extracted control variables for testing the stability and checking the errors; and
expressing the result of testing the stability and checking the errors on a display panel.

2. The method for testing the states in the flight plan state management system of claim 1, wherein the control variables for monitoring includes at least one of an aircraft waiting state, a modeling state, a preparation state, a departing state, an arriving state, and a termination state.

3. The method for testing the states in the flight plan state management system of claim 2, wherein the test of the stability is performed using the following equation based on a Bayesian network,
Pr(A|D,P,M,W)=Pr(W)Pr(M|W)Pr(P|W,T)Pr(D|P)Pr(A|D)
where W denotes a waiting state, M denotes a modeling state, P denotes a preparation state, D denotes a departing state, A denotes an arriving state, and T denotes a termination state.

4. The method for testing the states in the flight plan state management system of claim 2, wherein the test of the errors is performed through two following equations,
$${\overline{s}}_{i} = \frac{1}{N} {\sum }_{j ∈ V ( i )} {w}_{ij}$$
where V(i) denotes a node, wᵢⱼ denotes a weight value of a network link, and Ndenotes a total number of nodes,
Pr(A|D,P,M,W)=Pr(W)Pr(M|W)Pr(P|W,T)Pr(D|P)Pr(A|D)
where W denotes a waiting state, M denotes a modeling state, P denotes a preparation state, D denotes a departing state, A denotes an arriving state, and T denotes a termination state.

5. The method for testing the states in the flight plan state management system of claim 1, wherein the modeling is executed based on a network theory for modeling a weighted and directed network.

6. The method for testing the states in the flight plan state management system of claim 5, wherein the modeling is executed through calculation and analysis of internal parameters of a model using a complex network theory and statistical graphical models.

7. An apparatus for testing states in a flight plan state management system, comprising:
a monitoring definition block, which defines control variables for monitoring the flight plan state management system;
a modeling execution block, which executes modeling of the flight plan state management system based on the control variables defined for monitoring;
a stability/error control variable generation block, which calculates and extracts control variables for testing stability and checking errors of the flight plan state management system using a result of modeling;
a state management stability test block, which tests the stability of the flight plan state management system based on the calculated and extracted control variables for testing the stability;
a state management error checking block, which checks the errors of the flight plan state management system based on the calculated and extracted control variables for checking the errors; and
a screen expression block, which expresses the result of testing the stability and checking the errors on a display panel.

8. The apparatus for testing the states in the flight plan state management system of claim 7, wherein the monitoring definition block defines at least one of an aircraft waiting state, a modeling state, a preparation state, a departing state, an arriving state, and a termination state as the control variables for monitoring.

9. The apparatus for testing the states in the flight plan state management system of claim 8, wherein the stability test block tests the stability using the following equation,
Pr(A|D,P,M,W)=Pr(W)Pr(M|W)Pr(P|W,T)Pr(D|P)Pr(A|D)
where W denotes a waiting state, M denotes a modeling state, P denotes a preparation state, D denotes a departing state, A denotes an arriving state, and T denotes a termination state.

10. The apparatus for testing the states in the flight plan state management system of claim 8, wherein the error checking block tests the errors using two following equations,
$${\overline{s}}_{i} = \frac{1}{N} {\sum }_{j ∈ V ( i )} {w}_{ij}$$
where V(i) denotes a node, wᵢⱼ denotes a weight value of a network link, and Ndenotes a total number of nodes,
Pr(A|D,P,M,W)=Pr(W)Pr(M|W)Pr(P|W,T)Pr(D|P)Pr(A|D)
where W denotes a waiting state, M denotes a modeling state, P denotes a preparation state, D denotes a departing state, A denotes an arriving state, and T denotes a termination state.

11. The apparatus for testing the states in the flight plan state management system of claim 7, wherein the modeling execution block executes the modeling based on a network theory for modeling of a weighted and directed network.

12. The apparatus for testing the states in the flight plan state management system of claim 11, wherein the modeling is executed through calculation and analysis of internal parameters of a model using a complex network theory and statistical graphical models.
